(19) United States
(12) Patent Application Publication
(10) Pub. No.: US 2026/0236889 A1
(43) Pub. Date: Aug. 13, 2026

(54) COMPUTER SYSTEMS AND METHODS FOR GENERATING HIRING RECOMMENDATIONS

(71) Applicant: Capital One Financial Corporation, McLean, VA (US)

(72) Inventors: Yuan Xiang, Chicago, IL (US); Bowen Wu, Northbrook, IL (US)

(21) Appl. No.: 19/048,634

(22) Filed: Feb. 7, 2025

(51) Int. Cl. G06Q 10/1053

(52) U.S. Cl. CPC G06Q 10/1053

(57) ABSTRACT

A software-based pipeline that functions to (i) load source data for one or more candidates for prospective employment at an employer, (ii) based on the loaded source data, prepare input data for at least one artificial intelligence (AI) model that is configured to (a) receive an input dataset related to a candidate and (b) based on an evaluation of the input dataset, generate a prediction of how long the candidate is likely to stay with the employer if hired, (iii) utilize the at least one AI model to generate and output, for each respective candidate of the one or more candidates, a respective prediction of how long the respective candidate is likely to stay with the employer if hired, (iv) based on the output of the AI model, generate a recommendation to hire at least candidate from the one or more candidates.

### BACKGROUND

Employees are, in a sense, the backbone of most employers. In addition to performing the day-to-day work that generates the products or services that the employer offers, employees may also serve as innovators and brand ambassadors whose contributions can accelerate company growth and increase an employer's value and revenue. For these and other reasons, many employers invest significant time and effort into tasks such as hiring, managing, and retaining their employees.

### OVERVIEW

Disclosed herein is software technology for preemptively predicting how long candidates for prospective employment at an employer are likely to stay with the employer if hired and then using such predictions as a basis for performing other actions that assist the employer during its hiring process.

In one aspect, the disclosed technology may take the form of a method to be carried out by a computing platform that involves (i) loading source data for one or more candidates for prospective employment at an employer, (ii) based on the loaded source data, preparing input data for at least one artificial intelligence (AI) model that is configured to (a) receive an input dataset related to a candidate and (b) based on an evaluation of the received input dataset, generate a prediction of how long the candidate is likely to stay with the employer if the candidate were to be hired, (iii) utilizing the at least one AI model to generate and output, for each respective candidate of the one or more candidates, a respective prediction of how long the respective candidate is likely to stay with the employer if the respective candidate were to be hired, (iv) based on the output of the AI model, generating a recommendation to hire at least candidate from the one or more candidates, and (v) causing the recommendation to be presented to at least one user of the computing platform (e.g., by transmitting one or more messages that instruct a client device to present the recommendation to the at least one user).

The input dataset related to the candidate may take various forms, and in some example embodiments, may include one or both of (i) structured input data (which may be based on structured and/or unstructured source data) and/or (ii) unstructured input data.

Further, in some example embodiments, the method may additionally involve utilizing a model explainability technique to quantify and output, for each respective candidate of the one or more candidates, a respective set of feature contribution values for a set of feature variables, wherein the input data comprises respective feature values that map to the feature variables.

Further yet, in some example embodiments, the method may additionally involve training the at least one AI model by applying a machine-learning process to training data comprising historical data related to one or both of current employees of the employer or former employees of the employer.

Still further, in some example embodiments, the at least one AI model comprises a first AI model that is configured to receive a structured input dataset as input and a second AI model that is configured to receive an unstructured input dataset as input. And in such example embodiments, the function of utilizing the at least one AI model to generate and output, for each respective candidate of the one or more candidates, the respective prediction may involve (i) utilizing the first AI model to generate and output, for each respective candidate of the one or more candidates, a respective first intermediate prediction of how long the respective candidate is likely to stay with the employer if the respective candidate were to be hired, (ii) utilizing the second AI model to generate and output, for each respective candidate of the one or more candidates, a respective second intermediate prediction of how long the respective candidate is likely to stay with the employer if the respective candidate were to be hired, and (iii) aggregating the first intermediate prediction and the second intermediate prediction into the respective prediction of how long the respective candidate is likely to stay with the employer if the respective candidate were to be hired.

In another aspect, disclosed herein is a computing platform that includes a communication interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 an example network environment in which aspects of the disclosed software technology disclosed herein can be implemented.

FIG. 2 depicts a block diagram of an example software-based pipeline that carries out functionality disclosed herein.

FIG. 3 is a flow chart of example of functionality that may be carried out in accordance with the software technology disclosed herein.

FIG. 4 depicts a simplified block diagram to illustrate some structural components that may be included in an example computing platform that may be configured to perform some or all of the platform functions disclosed herein.

FIG. 5 depicts a simplified block diagram to illustrate some structural components that may be included in an example client device that may be configured to perform some or all of the client-device functions disclosed herein.

### DETAILED DESCRIPTION

As noted above, given the importance of employees to the success of most employers, such employers typically invest significant time and effort into tasks such as hiring, managing, and retaining their employees. And in order to perform these tasks effectively, an employer generally has to collect and analyze various types of data about current employees for management and retention purposes as well as prospective employees for hiring purposes.

For instance, in order to manage and retain current employees effectively, an employer may collect and maintain any of various different categories of data about its current employees, examples of which may include (i) personal data such as names, social security numbers, dates of birth, home addresses, email addresses, phone numbers, and emergency contacts, (ii) employment data such as job titles, departments, start dates, end dates (when applicable), work schedules, employment statuses (e.g., full time, part time, on leave, etc.) and employment contracts, (iii) payroll data such as salaries (e.g., for full-time employees), hourly rates (e.g., for part-time employees), commissions, incentives, bonuses, deductions (e.g., for taxes, insurance, etc.), account numbers (e.g., for direct deposits), and pay stubs, (iv) benefits data such as insurance data (e.g., provider and plan information for health, dental, vision, life, disability, and other types of insurance), paid time-off balances, sick leave, vacation time balances, and benefit eligibility data, (v) work-time data such as time clock entries, requests for time off, manager approvals of requests for time off, overtime eligibility, and amounts of overtime worked, (vi) compliance data such as employment eligibility documentation (e.g., I-9 forms for the United States), age verification documentation (e.g., to ensure compliance with child labor laws), and data identifying legally protected classes to which employees belong (e.g., classes protected under laws such as the Equal Employment Opportunity Act of 1972 and the Uniformed Services Employment and Reemployment Rights Act (USERRA) in the United States), among other possible examples of data categories related to current employees that may be collected and maintained by an employer.

In addition, in order to hire new employees effectively, an employer may collect and maintain any of various different categories of data about prospective employees (e.g., job applicants who have submitted résumés, cover letters, and other application materials in hopes of being hired by the employer), examples of which may include (i) personal information such as the types of personal information mentioned above), (ii) work history data such as previous employers, previous job titles, former dates of employment with previous employers, and previous job responsibilities, (iii) education data such as degrees held, training completed, professional licenses held, and certifications obtained, (iv) compliance data such as the types of compliance data mentioned above, and/or (v) assessment data such as answers to screening questions, notes from interviewers, and scores from assessment tests, among other possible examples of data categories related to prospective employees that may be collected and maintained by an employer.

However, as an employer grows, so too does the volume of data that it has to collect and maintain related to current and prospective employees, and at a certain point, it becomes practically impossible for an employer to collect and maintain data related to its current and prospective employees without the assistance of technology. For instance, there are many employers that have hundreds or even thousands of employees (e.g., such as the more than 100,000 employers worldwide that have more than the more than one hundred employees and the more than 24,000 employers worldwide that have more than one thousand employees), and as a practical matter, it is not possible for these employers to collect and manage data related to their current and/or prospective employee without the assistance of technology.

An employer's task of collecting and maintaining employee-related data is made even more difficult by the fact that at least some of the employee-related data is sensitive in nature and needs to be maintained in a secure way. Indeed, laws in many jurisdictions impose regulations about how sensitive data (e.g., social security numbers and other personal data) is to be used, handled, and stored. For instance, the General Data Protection Regulation (GDPR), which applies in European Union (EU) member states, mandates that appropriate measures be taken to secure personal data-and such appropriate measures may involve encrypting personal data (e.g., in accordance with Federal Information Processing Standards (FIPS) such as the Advanced Encryption Standard (AES)) via encryption algorithms. However, it is typically not possible for employers to comply with these regulations without the assistance of technology.

In view of the foregoing, technology has been developed to help employers collect, securely maintain, and effectively utilize data related to their current and/or prospective employees. Generally speaking, this technology takes the form of specialized software applications (e.g., software-as-a-service (Saas) applications) that provide functionality for collecting, securely maintaining, and utilizing data related to current and/or prospective employees in order to facilitate tasks related to managing, retaining, and/or hiring employees.

One example of the existing technology that provides functionality related to employee-related data is a category of software applications that are commonly referred to as Applicant Tracking System (ATS) applications, which provide various functionality for collecting, maintaining, and utilizing data related to prospective employees of an employer in order to facilitate tasks related to hiring of prospective employees. For example, existing ATS applications may provide various functionality that facilitates recruiting tasks related to prospective employees, such as collecting data about prospective employees, filtering prospective employees based on configurable criteria, ranking prospective employees, and sending status updates to prospective employees, among other functionality provided by existing ATS applications. Some representative examples of these existing ATS applications include HiredScore@, Recruiterflow®, RecruitBPM®, and Crelate®, among others.

As a practical matter, given the cumulative volume of the data that most employers collect and maintain about prospective employees, and given the consequences that may result from a failure to maintain that data properly, such employers have little choice but to use the types of software applications mentioned above. However, the existing ATS software applications are plagued by a number of drawbacks.

For instance, when evaluating candidates for prospective employment, employers generally wish to identify the candidates that, if hired, are likely to stay with the employer for a longer period of time, because those are the job applicants that are most likely to help improve the employer's productivity, value, and revenue and may also help to reduce future employee attrition. However, it is typically not possible for humans to accurately or reliably identify candidates that are likely to stay with the employer for a longer period of time given the many factors that go into that assessment-and while some existing ATS software applications provide user-configurable options for automatically flagging certain job applicants as desirable (e.g., job applicants whose résumés include specific keywords) and for automatically rejecting certain job applicants (e.g., job applicants who do not hold a particular professional license or a particular degree), existing ATS software applications lack the capacity to leverage historical employee-related data for a given employer in order to predict which candidates are likely to stay with the employer for a longer period of time if hired.

The drawbacks of the existing technologies listed above are merely illustrative, as there are other drawbacks and technical problems with existing ATS software applications.

To address these and other problems with existing technology for collecting, maintaining, utilizing, and analyzing data related to prospective employees, such as existing ATS applications, disclosed herein is new software technology for leveraging the employee-related data of an employer to assist with the task of hiring employees.

At a high level, the disclosed software technology may take the form of a software-based pipeline that carries out functionality for preemptively predicting how long candidates for prospective employment at an employer are likely to stay with the employer and then using such predictions as a basis for performing other actions that assist the employer during its hiring process, such as by surfacing insights about candidates and/or initiating software workflows related to hiring.

The disclosed technology may take other forms and include various other functionality as well.

In this way, the disclosed software technology includes specific data-driven capabilities that are predictive rather than solely reactive, thereby providing a number of advantages over existing ATS technologies.

For instance, the disclosed software technology implements a candidate prediction component that can predict how long a candidate is likely to stay with an employer if hired. The candidate-prediction component predicts how long a candidate is likely to stay with an employer with both accuracy and sufficient time granularity to reduce the extent and impact of future employee attrition (e.g., by apprising the employer of how long candidates are likely to stay before the employer decides whether or not to hire them).

Further, in at least some implementations, the software technology may include an explainability component that generates explanations that can elucidate why different candidates are predicted to stay with the employer for different lengths of time. In particular, the explainability component determines respective contribution values that reflect the extent to which different factors influenced the predictions made by the candidate-prediction component, thereby providing data that facilitate discovery of root causes of attrition for the employer specifically.

Further yet, in some implementations, the disclosed software technology provides a hiring-recommendation component that generates recommendations for which candidates to hire based on the predictions that are generated output by the candidate-prediction component (and, in some implementations, based on other data related to the candidates as well). In this manner, the hiring-8 recommendation component provides data-driven, unbiased analyses of candidates that help employers make better hiring decisions.

Still further, in some implementations, the software technology includes an output interface for presenting the output of the other components of the software technology to a user. The disclosed software technology also provides other advantages over the existing technology which are apparent from the detailed discussion of the software technology that follows.

In practice, the disclosed software technology may be incorporated into a software application that is hosted on a back-end computing platform and is accessible by client devices over a communication path that typically includes the Internet (among other data networks that may be included). In this respect, the disclosed software technology may comprise server-side software installed on the back-end computing platform as well as client-side software that runs on the client devices and interacts with the server-side software, which could take the form of a client application running in a web browser (sometimes referred to as a “web application”), a native desktop application, or a mobile application, among other possibilities. However, the software technology could take other forms and/or be implemented in other manners as well.

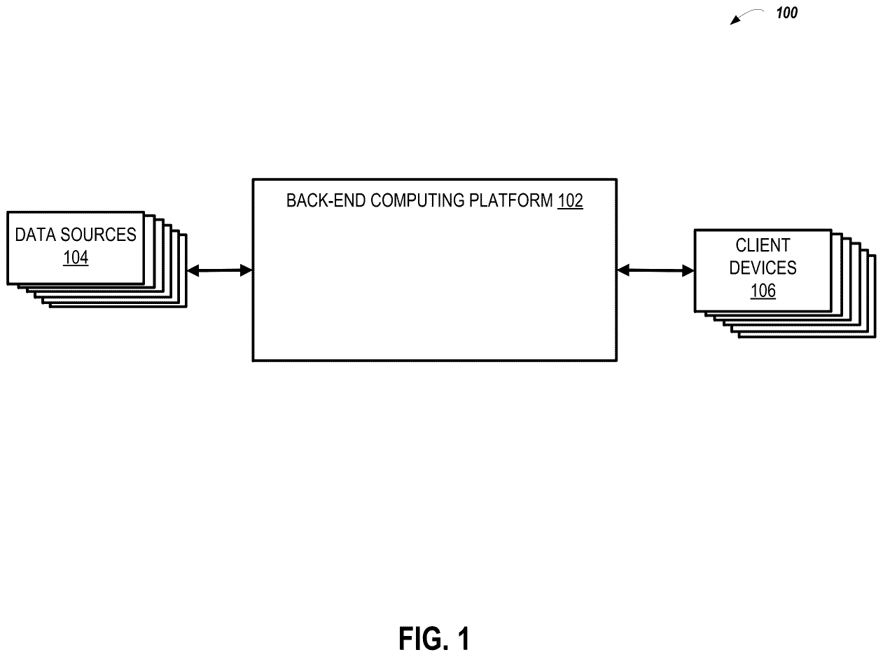

Turning now to the figures, FIG. 1 depicts one illustrative example of a computing environment 100 in which the disclosed software technology may be implemented. As shown, the example computing environment 100 may include a back-end computing platform 102 operated by on behalf of an entity that is involved in the task of recruiting, hiring, and/or managing, job candidates (which may at times be referred to herein as an “employer”), a plurality of data sources 104, and a plurality of client devices 106, among other possibilities.

The back-end computing platform 102 may comprise any one or more computer systems (e.g., one or more servers) that have been installed with software for carrying out the back-end functionality disclosed herein. In practice, the one or more computer systems of the back-end computing platform 102 may collectively comprise some set of physical computing resources (e.g., one or more processors, data storage system, communication interfaces, etc.), which may take any of various forms. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of the given provider (e.g., servers owned by the given provider). As yet another possibility, the back-end computing platform 102 may comprise a combination of cloud computing resources and on-premises computing resources. Other implementations of the back-end computing platform 102 are possible as well.

Further, in practice, the software for carrying out the back-end functionality disclosed herein may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the software for carrying out the back-end functionality disclosed herein may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities. Such a data storage layer of the back-end computing platform 102 may contain any of various types of data, including but not limited to any of the various types of data involved in carrying out the back-end functionality disclosed here (e.g., candidate-related data for job candidates).

As shown, the back-end computing platform 102 may be communicatively coupled to a plurality of data sources 104 over respective communication paths. In general, each of these data sources 104 may comprise a computing system that is configured to provide the back-end computing platform 102 with data related to the back-end functionality disclosed herein, such as candidate-related data for job applicants, among other possible types of data that may be provided by the data sources 104. As some representative examples, each such data source 104 could take the form of a computing platform that is running a software application for collecting and maintaining candidate-related data (e.g., ATS software), among various other possibilities.

As further shown, the back-end computing platform 102 may be communicatively coupled to a plurality of client devices 106 over respective communication paths. In general, each of these client devices 106 may comprise any computing device that enables a user to access and interact with the back-end computing platform 102 in order to carry out tasks related to the disclosed back-end functionality, such as configuration of the back-end functionality and/or evaluation of output provided by back-end computing platform 102. In this respect, each client device 106 may include hardware components such as one or more processors, computer-readable mediums, communication interfaces, and input/output (I/O) components (or interfaces for connecting thereto), among other possible hardware components, as well as software that enables a user to access and interact with the back-end computing platform 102 in order to carry out tasks related to the disclosed back-end functionality (e.g., operating system software, web browser software, a mobile application, etc.). As representative examples, each of example client devices 106 may take the form of a desktop computer, a laptop, a netbook, a tablet, a smartphone, or a personal digital assistant (PDA), among other possibilities.

In practice, the respective communication path between the back-end computing platform 102 and each data source 104 or client device 106 may generally comprise one or more data networks and/or data links, which may take any of various forms. For instance, the respective communication path between the back-end computing platform 102 and a given data source 104 or client device 106 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between the back-end computing platform 102 and a given data source 104 or client device 106 could be carried out via an Application Programming Interface (API), among other possibilities. Additionally, although not shown, the respective communication path between the back-end computing platform 102 and a given data source 104 or client device 106 could also include one or more intermediate systems, examples of which may include a data aggregation system or a host server, among other possibilities. Many other configurations are also possible.

It should be understood that the computing environment 100 is one example of a computing environment in which the disclosed software technology may be implemented, and that numerous other examples of computing environments are possible as well. For instance, in some implementations, the back-end computing platform 102 may additionally have a communication path with a third-party computing platform that is provided with access to data generated by the back-end computing platform 102 in accordance with the disclosed back-end functionality via an API or the like.

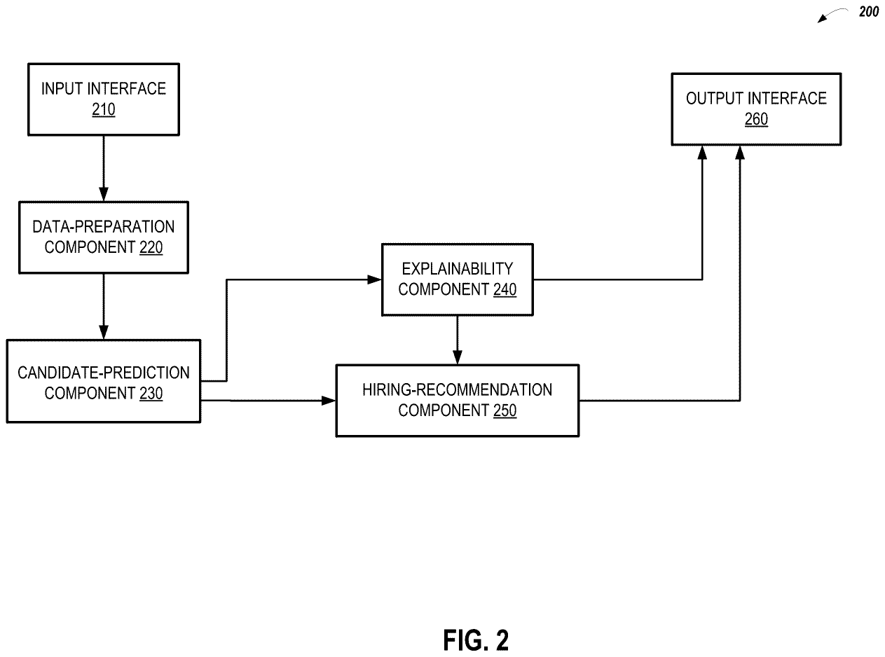

Turning now to FIG. 2, a block diagram of an example software-based pipeline 200 that carries out functionality for preemptively predicting how long candidates for prospective employment at an employer are likely to stay with the employer and then using such predictions as a basis for performing other functions that assist the employer during its hiring process is shown. In practice, the example software-based pipeline 200 may be encoded in the form of program instructions that are executable by one or more processors of a computing platform. For purposes of illustration, the example software-based pipeline 200 is described as being installed on and executed by the back-end computing platform 102 of FIG. 1, but it should be understood that the example software-based pipeline 200 may be installed on and executed by any one or more computing platforms that are capable of performing the example operations of the example software-based pipeline 200. Further, it should be understood that the example software-based pipeline 200 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown, the example software-based pipeline 200 may comprise an input interface 210, a data-preparation component 220, a candidate-prediction component 230, an explainability component 240, a hiring-recommendation component 250, and an output interface 260, each of which will be described in further detail below. Other implementations of the example software-based pipeline 200 are also possible.

As shown in FIG. 2, the example software-based pipeline 200 may begin with the input interface 210, which functions to (i) load data related to one or more candidates for prospective employment at the employer, which may be referred to herein as “source data,” and then (ii) pass the loaded source data to the data-preparation component 220. The source data for the one or more candidates that may be loaded by the input interface 210 may take any of various forms.

For instance, as one possibility, the source data that is loaded by the input interface 210 may include structured source data (sometimes referred to as “tabular” source data), which may generally take the form of values for some set of defined numerical and/or categorical variables related to the one or more candidates. Some illustrative examples of types of structured source data that may be loaded by the input interface 210 for the one or more candidates may include educational data (e.g., degrees held and dates obtained, grade point averages (GPAs) for different degrees, training completed and dates of completion, professional licenses and/or certifications held and dates obtained, etc.), language fluencies, career history data (e.g., years of experience, areas of specialization, typing speed, skills, etc.), salary data (e.g., prior salary, requested salary, etc.), and/or certain types of personal data (e.g., home address, extracurricular activities, hobbies, etc.), results of online behavior, and/or technical tests intended for the opening roles, among other possible types of structured source data that may be loaded for the one or more candidates.

As another possibility, the source data that is loaded by the input interface 210 may include unstructured source data (sometimes referred to as “raw” source data), which may generally comprise data that does not take the form of values for defined numerical and/or categorical variables. Some illustrative examples of types of unstructured source data that may be loaded by the input interface 210 for the one or more candidates may include textual descriptions related to the one or more candidates (e.g., textual descriptions generated in connection with candidate interviews such as notes written by interviewers and/or interview transcripts, emails received from candidates, cover letters and/or résumés that include searchable text, text found on social media profiles of candidates, etc.), audio data related to the one or more candidates (e.g., audio recordings of interviews and/or telephone conversations with candidates), and/or image data related to the one or more candidates (e.g., scanned images of cover letters and/or résumés, images found in social media profiles of candidates, video recordings of interviews, etc.).

It should be understood that the unstructured source data may, in some instances, include information that overlaps with information found in the structured source data. For instance, an image of a résumé that does not include searchable text (e.g., text in a format such as American Standard Code for Information Interchange (ASCII), Universal Character Encoding (Unicode), etc.) may depict a candidate's contact information, educational data, career data, and/or other types of data. In general, the difference between structured source data and unstructured source data relates to the types of formats in which data are stored rather than to the substance of the information that the data represent.

The input interface 210 may load other types of source data for the one or more candidates as well.

Further, in practice, the one or more candidates for which the source data is loaded could comprise a single candidate that is being evaluated for some position within the employer, multiple candidates that are being evaluated for a same position within the employer, or multiple candidates that are being evaluated for multiple different positions within the employer, among other possibilities.

Further yet, the function of loading the source data for the one or more candidates may take any of various forms. For instance, as one possibility, the function of loading the source data for the one or more candidates may involve retrieving at least a portion of the source data from a data storage layer of the back-end computing platform 102, which may contain source data that was previously received by the back-end computing platform 102 from another data source 104 and/or was previously generated by the back-end computing platform 102.

As another possibility, the function of loading the source data for the one or more candidates may involve obtaining at least a portion of the source data from one or more data sources 104, such as by causing the back-end computing platform 102 to send a request for source data to a given data source 104 via a network-based communication path (e.g., in the form of a HyperText Transfer Protocol (HTTP) request or the like) and then receive the source data back from the given data source 104 via the network-based communication path (e.g., in the form of an HTTP response or the like). In this respect, as noted above, the one or more data sources 104 may take any of various forms, one example of which may be a separate computing platform that is running a software application for collecting and maintaining source data (e.g., ATS software).

As yet another possibility, the function of loading the source data for the one or more candidates may involve retrieving a first portion of the source data from a data storage layer of the back-end computing platform 102 and obtaining a second portion of the source data from one or more data sources 104.

The function of loading the source data for the one or more candidates may take other forms as well.

As discussed above, the input interface 210 may be configured to pass the loaded source data to the data-preparation component 220 of the example software-based pipeline 200, which may function to (i) pre-process the loaded source data so as to prepare it for input into the candidate-prediction component 230 and then (ii) pass the pre-processed source data to the candidate-prediction component 230. In this respect, the pre-processed source data that is passed to the candidate-prediction component 230 may be referred to herein as “feature data.” The form of the feature data that is to be provided as input to the candidate-prediction component 230—and the functionality for preparing such feature data for input to the candidate-prediction component 230—may take any of forms.

For instance, in at least some implementations, the candidate-prediction component 230 may be configured to receive input data in the form of a set of data records that each represent a respective candidate and contain respective values for a given set of feature variables-which may collectively be referred to as “structured” feature data-and the data-preparation component 220 may be configured to transform the loaded source data into this structured feature data. Such feature variables may take any of various forms, examples of which may include feature variables related to a candidate's educational background, language fluencies, career history, salary history, salary demands, personal background, online behavior, and/or competency for the position, among various other possible types of feature variables.

Additionally or alternatively, the candidate-prediction component 230 may be configured to receive input data in the form of unstructured data related to a candidate-which may be referred to herein as “unstructured” feature data-and the data-preparation component 220 may be configured to transform the loaded source data into this unstructured feature data. Such unstructured feature data may take include textual data, audio data, image data, and/or video data related to the candidate.

Further, the pre-processing functions that are applied to the source data may take various forms and may depend on the nature of the source data that is received from the input interface 210 as well as the feature data that is to be input into the candidate-prediction component 230. For instance, as discussed above, the source data may comprise either or both of structured source data and/or unstructured source data. Likewise, as discussed further below, the candidate-prediction component 230 may generate candidate predictions based on either or both of structured feature data (e.g., values for some set of defined numerical and/or categorical feature variables related to the one or more candidates) and/or unstructured feature data (e.g., textual data, audio data, and/or image data). In this respect, the pre-processing functions utilized by the data-preparation component 220 may vary depending on whether the source data and feature data is structured or unstructured.

As one possibility, the data-preparation component 220 may be configured to receive structured source data and then produce structured feature data based on that structured source data. The pre-processing functions involved in performing this operation may take various forms.

As one example, the pre-processing functions involved in producing structured feature data based on structured source data may involve mapping source data variables to feature data variables. For instance, in some cases, a given feature variable and a given source variable may both represent a same attribute, and the data-preparation component 220 may have access to a data model (e.g., a source-to-feature mapping) that indicates the relationship between the given source variable maps and the given feature variable. When the data-preparation component 220 identifies a value for the given source variable in the structured source data for a given candidate (e.g., as a result of parsing the structured source data), the data-preparation component 220 may utilize the data model to map the value for the given source variable to a value for the given feature variable.

In some cases, the structured source data may indicate a format for the given source variable. The manner in which the structured source data indicates this format may depend on the specific form of the structured source data. For instance, if the structured source data is stored in an ARFF file, the format for the source variable may be specified by a “<datatype>” parameter for an attribute corresponding to the given source variable. If the structured source data is stored as a spreadsheet, the format for the source variable may be specified by metadata for a column that that corresponds to the given source variable. The manner in which the structured source data indicates the format for the given source variable may also take other forms (e.g., in accordance with the form of the structured source data and a schema therefore). Similarly, a format for the given feature variable may be indicated based on a form specified for the structured feature data.

If the format for the given source variable matches the format for the given feature variable, the data-preparation component 220 may utilize the value for the given source variable as the value for the given feature variable. Alternatively, if the format for the given source variable does not match the format for the given feature variable, the data-preparation component 220 may transform the value for the given source variable from its original format into the format of the given feature value, which may involve functions such as converting from one unit type to another (e.g., months to years, etc.), changing a number of decimal places (e.g., by rounding, truncating, etc.), converting from one variable type to another (e.g., numerical to categorical, etc.), changing a scale (e.g., converting from a linear scale to a logarithmic scale), and/or normalizing, among other possible types of transformation functions.

As another example, the pre-processing functions involved in producing structured feature data based on structured source data may involve deriving a feature value for a feature variable based on two or more source variables.

In this example a given feature variable may be defined as a function of two or more source variables, the data-preparation component 220 may have access to a data model that indicates the relationship between the given feature variable and the two or more source variables. When the data-preparation component 220 identifies values for the two or more source variables in the structured source data for a given candidate (e.g., as a result of parsing the structured source data), the data-preparation component 220 may utilize the values for the two or more source values as actual parameters (i.e., arguments) for the function of the two or more source variables to compute a value for the given feature variable.

For instance, consider a scenario in which the given feature variable represents a difference between a first GPA for an undergraduate degree and a second GPA for a master's degree. In this scenario, the function that defines the given feature variable may specify that the GPA for the undergraduate degree be subtracted from the GPA for the master's degree, and to compute a value for the given feature variable for a given candidate, the data-preparation component 220 may subtract the value for a source variable that represents the first GPA from the value for a source variable that represents the second GPA.

As another illustrative example, consider a scenario in which the given feature variable represents a distance between a home address of a candidate and an office address of an office where the candidate would be expected to work if hired. In this scenario, the function that defines the given feature variable may specify that the value of the given feature variable is a distance (e.g., a road distance, a Euclidean distance, etc.) between the home address and the office address. to compute a value for the given feature variable for a given candidate, the data-preparation component 220 may send a request to a data source (e.g., one of the plurality of data sources 104 shown in FIG. 1) that stores mapping data (e.g., Google® Maps) via a network-based communication path. The request may indicate the home address and the office address and may request that a road distance between the home address and the office address be returned in response to the request. Alternatively, the data-preparation component 220 may load a map from a data source and compute the distance based on a scale of the map.

Other examples involving different numbers of source variables and different types of computations are also possible.

The pre-processing functions involved in producing structured feature data based on structured source data may also take other forms.

As another possibility, the data-preparation component 220 may be configured to receive unstructured source data and then produce structured feature data based on that unstructured source data. The pre-processing functions involved in performing this operation may take various forms, which may depend in part on the type of unstructured source data that is received from the input interface 210.

In a first scenario where the unstructured source data includes textual data, the data-preparation component 220 may apply a technique for transforming the textual data into structured feature data, which is sometimes referred to as “text vectorization.” Examples of such text vectorization techniques may include Bag of Words (BoW), Term Frequency Inverse Document Frequency (TF-IDF), Word2Vec, and/or One Hot encoding, among other possible vectorization techniques. In this scenario, the structured feature data that is produced by the data-preparation component 220 may comprise values for some set of defined numerical and/or categorical variables that represent the words found within the textual data. Additionally, prior to performing text vectorization, the data-preparation component 220 may also apply one or more other pre-processing techniques in order to prepare the textual data for transformation into the structured feature data, examples of which may include data cleaning, stop word removal, stemming, lemmatization, and/or tokenization, among other possibilities.

In a second scenario where the unstructured source data includes audio data, the data-preparation component 220 may apply a technique for transforming the audio data into structured feature data. For instance, the data-preparation component 220 may first apply a speech-recognition technique to generate a textual transcription of the audio data and may then apply a text vectorization technique to the textual transcription. Alternatively, the data-preparation component 220 may apply an audio vectorization technique to the audio data, examples of which may include Wav 2 Vec 2.0 and the techniques employed by the Librosa library. In this scenario, the structured feature data that is produced by the data-preparation component 220 may comprise values for some set of defined numerical and/or categorical variables that represent one or both of (i) the text transcribed from the audio data or (ii) the characteristics of the audio data.

In a third scenario where the unstructured source data includes image data, the data-preparation component 220 may apply a technique for transforming the image data into structured feature data. For instance, the data-preparation component 220 may first apply optical character recognition (OCR) to the image data in order extract text from the image data and may then apply a vectorization technique to the extracted text. Alternatively, the data-preparation component 220 may apply a feature extraction technique to the image data. In this scenario, the structured feature data that is produced by the data-preparation component 220 may comprise values for some set of defined numerical and/or categorical variables that represent one or both of (i) the text found within the image data or (ii) the features extracted from the image data.

The pre-processing functions involved in producing structured feature data from unstructured source data may also take other forms.

As yet another possibility, the data-preparation component 220 may be configured to receive unstructured source data and then produce unstructured feature data based on that unstructured source data. The pre-processing functions involved in performing this operation may take various forms, examples of which may include data cleaning (e.g., correcting misspelled words, correcting syntax errors, converting letters to lower and/or upper case, etc.), stop word removal, stemming, lemmatization, and/or tokenization, among other possibilities.

The pre-processing functions involved in producing unstructured feature data from unstructured source data may also take other forms.

After pre-processing the source data, the data-preparation component 220 may pass the pre-processed source data (i.e., the feature data) to the candidate-prediction component 230, which may generally function to (i) predict how long each of the one or more candidates is likely to stay with the employer and then (ii) pass each such prediction (which may at times be referred to herein as a “tenure prediction”) to other components of the pipeline that are configured to use the predictions as a basis for performing other functions that assist the employer during its hiring process. The functionality that is carried out by the candidate-prediction component 230 to predict how long each of the one or more candidates is likely to stay with the employer may take any of various forms.

In at least some embodiments, the candidate-prediction component 230 may predict how long each of the one or more candidates is likely to stay with the employer utilizing one or more artificial intelligence (AI) models, each of which may take any of various forms-including any of various forms of AI models that may be created utilizing a machine-learning process involving one or more machine learning techniques (e.g., supervised, semi-supervised, and/or unsupervised machine learning techniques). For example, the one or more AI models that may be utilized by the candidate-prediction component 230 to predict how long each of the one or more candidates is likely to stay with the employer may include any one or more of a regression model, a decision-tree-based model (e.g., a gradient boosting model, random forest model, etc.), a support vector machine (SVM)-based model, a Bayesian model, a k-Nearest Neighbor (kNN) model, a Gaussian process model, a deep learning model (e.g., a feedforward, recurrent, or convolutional neural-network model, a transformer-based model, a generative adversarial network (GAN) model, an autoencoder-based model, etc.), a clustering model, an association-rule model, a dimensionality-reduction model, and/or a reinforcement-learning model, among other possible examples of AI models that can be created using machine learning techniques. And depending on the form of the AI model, the input and output of the AI model may likewise take any of various forms.

For instance, as one possibility, the candidate-prediction component 230 may predict how long each of the one or more candidates is likely to stay with the employer utilizing a first type of AI model that is configured to (i) receive structured feature data for a candidate comprising values for a given set of feature variables and (ii) based on an evaluation of the structured feature data, generate and output a prediction of how long the candidate is likely to stay with the employer. This first type of AI model may take any of various forms.

To begin, the given set of structured feature variables that define the input of the first type of AI model may include any of various types of feature variables that may be predictive of how long the candidate is likely to stay with the employer, including, but not limited to, any of various types of feature variables described above. For example, in line with the discussion above, the given set of structured feature variables could include (i) feature variables having values that are determined based on structured source data (e.g., features extracted from numerical or categorical source values), (ii) feature variables having values that are determined based on unstructured source data (e.g., features extracted from source text, audio, or images), or (iii) a combination thereof.

Further, the prediction of how long the candidate is likely to stay with the employer that is generated and output by the first type of AI model could take the form of (i) a numerical value that quantifies how long the candidate is likely to stay with the employer, such as a number of days, weeks, months, years, or the like, and/or (ii) a categorical value that indicates how long the candidate is likely to stay with the employer, such as “short,” “medium,” or “long,” among various other possibilities.

Further yet, the first type of AI model may comprise any form of AI model that is capable of receiving structured feature data and then outputting a numerical or categorical output value, examples of which may include a regression model, a decision-tree-based model, an SVM-based model, a Bayesian model, a kNN model, a Gaussian process model, a deep learning model, and/or a clustering model, among other possibilities.

Still further, depending on the form of the first type of AI model, the process of creating the first type of AI model may take various forms. As one possible example, that process may involve (i) identifying current and/or former employees of the employer to use as the basis for training the AI model, (ii) obtaining a training dataset for training the AI model, which may comprise (a) data records for the current and/or former employees that include values for the given set of feature variables (and perhaps other candidate feature variables) along with (b) corresponding ground-truth values (sometimes referred to as “labels”) indicating how long the current and/or former employees stayed with the employer, and then (ii) applying a machine-learning process (e.g., a process involving supervised, semi-supervised, and/or unsupervised machine learning techniques) to the training data one or more times in order to train one or more instances of the AI model. Further, in scenarios where a single instance of the AI model is trained, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained (e.g., through the use of different sets of hyperparameters), the process of creating the AI model may additionally involve comparing the performance of the multiple instances of the AI model utilizing a validation dataset (or sometimes referred to as a “test dataset”) that has a similar form to the generated training dataset and then selecting the instance of the AI model having the best performance. The process of creating the first type of AI model may take various other forms as well-including, but not limited to, the possibility that the first type of AI model could be re-trained and/or refined (e.g., via reinforcement learning) based on additional data that may become available after training.

The first type of AI model may take various other forms as well.

As another possibility, the candidate-prediction component 230 may predict how long each of the one or more candidates is likely to stay with the employer utilizing a second type of AI model that is configured to (i) receive unstructured feature data for a candidate and (ii) based on an evaluation of the unstructured feature data, generate and output a prediction of how long the candidate is likely to stay with the employer. This second type of AI model may take any of various forms.

To begin, the unstructured feature data for the candidate that is received as input by the second type of AI model may take the form of textual data related to the candidate (e.g., a textual description of the candidate), audio data related to the candidate (e.g., an audio memo the contains a description of the candidate and/or an audio recording of an interview with the candidate), and/or video data related to the candidate (e.g., a video recording of an interview with the candidate), although other forms of unstructured feature data are possible as well image data, etc.).

Further, similar to the first type of AI model, the prediction of how long the candidate is likely to stay with the employer that is generated and output by the second type of AI model could take the form of (i) a numerical value that quantifies how long the candidate is likely to stay with the employer, such as a number of days, weeks, months, years, or the like, and/or (ii) a categorical value that indicates how long the candidate is likely to stay with the employer, such as “short,” “medium,” or “long,” among various other possibilities.

Further yet, the second type of AI model may comprise any form of AI model that is capable of receiving unstructured feature data (e.g., at least text) and then outputting a numerical or categorical output value, examples of which may include a deep learning model such as a feedforward, recurrent, and/or convolutional neural-network model, a transformer-based model (e.g., a model based on a Bidirectional Encoder Representations from Transformers (BERT) architecture), a GAN model, or an autoencoder-based model, among other possibilities.

Still further, depending on the form of the second type of AI model, the process of creating the second type of AI model may take various forms. As one possible example, that process may involve (i) identifying current and/or former employees of the employer to use as the basis for training the AI model, (ii) obtaining a training dataset for training the AI model, which may comprise (a) unstructured feature data for the current and/or former employees (e.g., textual descriptions of the current and/or former employees) along with (b) corresponding ground-truth values (sometimes referred to as “labels”) indicating how long the current and/or former employees stayed with the employer, and then (ii) applying a machine-learning process (e.g., a process involving supervised, semi-supervised, and/or unsupervised machine learning techniques) to the training data one or more times in order to train one or more instances of the AI model. Further, in scenarios where a single instance of the AI model is trained, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained (e.g., through the use of different sets of hyperparameters), the process of creating the AI model may additionally involve comparing the performance of the multiple instances of the AI model utilizing a validation dataset (or sometimes referred to as a “test dataset”) that has a similar form to the generated training dataset and then selecting the instance of the AI model having the best performance.

As another possible example, the process of creating the second type of AI model may involve (i) obtaining an instance of a pre-trained AI model (e.g., a pre-trained transformed-based model such as a BERT-based model), (ii) identifying current and/or former employees of the employer to use as the basis for fine tuning the pre-trained AI model, (iii) obtaining a training dataset for fine tuning the pre-trained AI model, which may comprise (a) unstructured feature data for the current and/or former employees (e.g., textual descriptions of the current and/or former employees) along with (b) corresponding ground-truth values (sometimes referred to as “labels”) indicating how long the current and/or former employees stayed with the employer, and then (iv) fine tuning the pre-trained AI model based on the training dataset (e.g., by applying one or more supervised fine-tuning techniques) one or more times in order to train one or more instances of the AI model. Further, in scenarios where a single instance of the AI model is trained via fine tuning, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained via fine turning (e.g., through the use of different sets of hyperparameters), the process of creating the AI model may additionally involve comparing the performance of the multiple instances of the AI model utilizing a validation dataset (or sometimes referred to as a “test dataset”) that has a similar form to the generated training dataset and then selecting the instance of the AI model having the best performance.

The process of creating the second type of AI model may take various other forms as well-including, but not limited to, the possibility that the second type of AI model could be re-trained and/or refined (e.g., via reinforcement learning) based on additional data that may become available after training.

The second type of AI model may take various other forms as well.

The candidate-prediction component 230 may utilize other types of AI models to predict how long each of the one or more candidates is likely to stay with the employer as well.

Further, in practice, the candidate-prediction component 230 may be configured to predict how long each of the one or more candidates is likely to stay with the employer utilizing either (i) a single AI model, which could be of the first type or the second type, or (ii) multiple AI models that are of the same type and/or of different types, in which case the candidate-prediction component 230 may additionally function to aggregate the outputs of the multiple AI models (e.g., by determining a mean, maximum, minimum, etc. of the model outputs).

For instance, in one implementation, the candidate-prediction component 230 may be configured to predict how long each of the one or more candidates is likely to stay with the employer utilizing a single AI model of the first type that is configured to receive values for a single set of feature variables (e.g., feature variables that are based on structured source data, unstructured source data, or a combination thereof). And in such an implementation, the feature data that is passed from the data-preparation component 220 to the candidate-prediction component 230 may comprise a single set of structured feature data for each candidate.

In another implementation, the candidate-prediction component 230 may be configured to predict how long each of the one or more candidates is likely to stay with the employer utilizing two AI models of the first type: (1) a first AI model that is configured to receive values for a first set of feature variables that are determined based on structured source data (e.g., features extracted from numerical or categorical source values) and (2) a second AI model that is configured to receive values for a second set of feature variables that are determined based on unstructured source data (e.g., features extracted from source text, audio, or images). And in such an implementation, the feature data that is passed from the data-preparation component 220 to the candidate-prediction component 230 may comprise two sets of feature data for each candidate: (1) a first set of structured feature data that is based on structured source data and (2) a second set of structured feature data that is based on unstructured source data. Further, in such an implementation, the candidate-prediction component 230 may aggregate the outputs of the two AI models of the first type for each of the candidates so as to generate an overall prediction of how long each of the one or more candidates is likely to stay with the employer.

In yet another implementation, the candidate-prediction component 230 may be configured to predict how long each of the one or more candidates is likely to stay with the employer utilizing one AI model of the first type and one AI model of the second type. And in such an implementation, the feature data that is passed from the data-preparation component 220 to the candidate-prediction component 230 may comprise two sets of feature data for each candidate: (1) a first set of structured feature data and (2) a second set of unstructured feature data (e.g., a textual description of the candidate). Further, in such an implementation, the candidate-prediction component 230 may aggregate the outputs of the two AI models of the first type for each of the candidates so as to generate an overall prediction of how long each of the one or more candidates is likely to stay with the employer.

Other implementations of AI models are possible as well.

The candidate-prediction component 230 may predict how long each of the one or more candidates is likely to stay with the employer in other manners as well.

The explainability component 240 may function to generate explanations for at least a subset of the predictions that are generated and output by the candidate-prediction component 230 (e.g., predictions of how long candidates are likely to stay with the employer) and then pass the generated explanations to the output interface 260 for presentation to a user who wishes to understand why different candidates are predicted to stay with the employer for different lengths of time. This function of generating explanations for predictions may take any of various forms.

For instance, in implementations where the predictions are generated using the first type of AI model described above (e.g., an AI model that receives structured feature data as its input), the function of generating explanations for a prediction may involve utilizing a model explainability technique (sometimes referred to as a model interpretability technique) to quantify the contributions of the feature variables that define the AI model's input to a particular prediction that is generated and output by the AI model. In other words, the model explainability technique may determine an extent to which each of the AI model's feature variables influences a particular prediction that is generated and output by the AI model. For instance, if an AI model receives a set of structured feature data for a candidate that includes values for a given set of feature variables and then generates and outputs a prediction of how long the candidate is likely to stay with the employer, the explainability component 240 may utilize a model explainability technique to quantify the contributions of the different feature variables to the prediction, where some of the feature variables may have had a larger impact on the AI model's prediction of how long the candidate is likely to stay with the employer, while others of the feature variables may have had a smaller impact on the AI model's prediction of how long the candidate is likely to stay with the employer. In this respect, the contributions of the feature variables to the prediction could be quantified in terms of a set of contribution values (or “scores”) for the feature variables.

To illustrate with a simplified example, consider an example AI model that is configured to receive input values for three feature variables: (1) years of experience, (2) highest educational degree competed, and (3) distance between home and office. If this example AI model receives a set of structured feature data comprising values for these three feature variables and then generates and outputs a prediction of how long the candidate is predicted to stay with the employer, the explainability component 240 may then utilize a model explainability technique to quantify the contributions of the three feature variables to that prediction in terms of a first contribution value for the first feature variable, a second contribution value for the second feature variable, and a third contribution value for the third feature variable. In this respect, the contribution values may indicate which of the three feature variables had the most influence on the prediction of how long the candidate is predicted to stay with the employer.

In these implementations, the explainability technique that is utilized to quantify the contributions of an AI model's feature variables may take any of various forms, examples of which may include a game-theoretic explainability technique (e.g., a technique that determines or approximates Shapley values, Owen values, Banzhaf-Owen values, etc.), of which SHapley Additive explanations (SHAP) is a particular example, a Local Interpretable Model-agnostic Explanations (LIME) technique, a plot-based explainer technique (e.g., Partial Dependence Plots (PDP), Individual Conditional Expectation (ICE) plots, Accumulated Local Effects (ALE), etc.), a gradient-based technique, and/or a layer wise relevance propagation (LRP) technique, among other possible types of model explainability techniques that may be utilized to generate explanations for an AI model that is configured to receive structured feature data. The explainability technique may also take other forms.

Using the foregoing functionality, the explainability component 240 may determine a respective set of feature contribution values for each of the one or more candidates for whom predictions are made (or a subset thereof). For instance, the explainability component 240 may determine a first set of feature contribution values for a first candidate, a second set of feature contribution values for a second candidate, and so on for any other candidate. This function of generating explanations for the predictions that are generated and output by the candidate-prediction component 230 may take other forms as well.

As another possibility, in implementations where the predictions are generated using the second type of AI model described above (e.g., an AI model that receives unstructured feature data as its input) and that second type of model receives textual feature data as an input, the function of generating explanations for a prediction may involve utilizing a model explainability technique (sometimes referred to as a model interpretability technique) to quantify the contributions of textual segments (e.g., individual words or phrases) appearing within textual feature data provided as input to the AI model to the prediction that is generated and output by the AI model. In other words, the model explainability technique may determine an extent to which each of the textual segments appearing within the textual feature data (which are considered the “features” for explainability purposes) influences the prediction that is generated and output by the AI model. In this respect, the contributions of the textual segments to the prediction could be quantified in terms of a set of segment contribution values (or “scores”) for the textual segments.

The model explainability technique that is utilized to quantify the contributions of the textual segments appearing within the textual feature data provided as input to the second type of AI model to the prediction that is generated and output by the second type of AI model may take any of various forms, examples of which may include a game-theoretic explainability technique (e.g., a technique that determines or approximates Shapley values, Owen values, Banzhaf-Owen values, etc.), of which SHAP is a particular example, a LIME technique, a plot-based explainer technique (e.g., PDP, ICE, ALE, etc.), a gradient-based technique, and/or an LRP technique, among other possible types of model explainability techniques that may be utilized to generate explanations for an AI model that is configured to receive unstructured feature data comprising textual segments.

Using the foregoing functionality, the explainability component 240 may determine a respective set of segment contribution values for each of the one or more candidates for whom predictions are made (or a subset thereof), which may then be utilized to evaluate the extent to which each of the textual segments appearing within the textual feature data contributed to each of the second type of AI model's predictions.

As yet another possibility, in implementations where the predictions are generated using the second type of AI model described above (e.g., an AI model that receives unstructured feature data as its input), the function of generating explanations for a prediction may involve utilizing methods like Attention Visualization, which provides an indication of which parts of the input the AI model attends to or finds important. For example, when the unstructured feature data includes textual data, this function may involve visualizing attention weights to see which words or phrases the model is focusing on. As another example, when the unstructured feature data includes audio data, this function may involve highlighting which parts of the audio signal are most relevant.

As still another possibility, in implementations where the predictions are generated using the second type of AI model described above (e.g., an AI model that receives unstructured feature data as its input), the function of generating explanations for a prediction may involve utilizing methods like Integrated Gradients to understand the contributions of specific tokens and/or other parts of the input.

The functionality carried out by the explainability component 240 may take other forms as well.

Turning next to the hiring-recommendation component 250, that hiring-recommendation component 250 may be configured to (i) generate recommendations for which candidates to hire based on the predictions that are generated output by the candidate-prediction component 230 (and perhaps also other data related to the candidates) and (ii) pass each such hiring recommendation to the output interface 260 for presentation to a user. In addition, in some implementations, the hiring-recommendation component 250 may initiate a software workflow related to hiring. The functionality that is carried out by the hiring-recommendation component 250 to generate such hiring recommendations may take any of various forms.

For instance, as one possibility, the hiring-recommendation component 250 may apply logic to determine whether to make a hiring recommendation on a candidate-by-candidate basis. The function of determining whether to make a hiring recommendation for each candidate may take various forms.

As one example, the hiring-recommendation component 250 may determine whether to make a hiring recommendation for a given candidate by evaluating whether a length of time that the given candidate is predicted to stay with the employer (e.g., as predicted by the candidate-prediction component 230) satisfies a threshold condition. For instance, if the length of time that the given candidate is predicted to stay with the employer is greater than (or, in some implementations, at least equal to) a threshold length of time, the hiring-recommendation component 250 may recommend that the given candidate be hired. On the other hand, if the length of time that the given candidate is predicted to stay with the employer is less than a threshold length of time, the hiring-recommendation component 250 may not recommend that the given candidate be hired (or may even recommend against hiring the given candidate).

As another example, the hiring-recommendation component 250 may determine whether to make a hiring recommendation for a given candidate by evaluating the length of time that the given candidate is predicted to stay with the employer (i.e., the predicted tenure of the given candidate) along with one or more additional factors related to the given candidate. These additional factors could take any of various forms, examples of which may include the factors related to the given candidate's education, professional licenses and/or certifications, experience, and/or salary demands, among others.

For instance, in one scenario, the hiring-recommendation component 250 may begin by evaluating whether the predicted tenure of the given candidate satisfies a threshold condition related to predicted tenure. If the predicted tenure does not satisfy the threshold condition related to predicted tenure, the hiring-recommendation component 250 may remove the given candidate from consideration. Alternatively, if the predicted tenure does satisfy the threshold condition related to predicted tenure, the hiring-recommendation component 250 may determine whether the given candidate satisfies one or more additional conditions that have been designated as required for a position for which the given candidate is being considered. Illustrative examples of additional conditions include holding one or more types of educational degrees, holding one or more types of professional licenses and/or certifications, having at least a threshold number of years of experience, and/or having one or more types of skills, among other possible examples. If each of the additional conditions is satisfied, the hiring-recommendation component 250 may recommend that the given candidate be hired. If any of the additional conditions are not satisfied, the hiring-recommendation component 250 may remove the given candidate from consideration.

The function of determining whether to make a hiring recommendation for each candidate may also take other forms.

As another possibility, the hiring-recommendation component 250 may apply logic to generate hiring recommendations on a position-by-position basis. The function of generating a hiring recommendation for a given position may take various forms.

As one example, the hiring-recommendation component 250 may begin by identifying one or more candidates who are being considered for the given position. Optionally, the hiring-recommendation component 250 may filter out candidates who do not satisfy one or more conditions (e.g., such as the conditions described above with respect to candidate-by-candidate recommendations). If a single candidate remains after candidates who do not satisfy the one or more conditions have been filtered out, the hiring-recommendation component 250 may recommend that the single candidate by hired to fill the given position. If the more than one candidate remains after candidates who do not satisfy the one or more conditions have been filtered out, the hiring-recommendation component 250 may apply logic to rank the remaining. The logic that the hiring-recommendation component 250 applies to rank the candidates may take any of various forms.

In one scenario, the hiring-recommendation component 250 may rank the candidates in the set based on a single factor. For instance, the hiring-recommendation component 250 may rank the candidates according to their predicted tenures (e.g., by ranking candidates in descending order according to their predicted tenures), their years of experience (e.g., by ranking candidates in descending order according to their years of experience), their degrees held (e.g., by ranking candidates who hold doctoral level degrees above candidates who do not, candidates who have master's degrees above candidates that do not, and so forth), or some other single factor.

In another scenario, the hiring-recommendation component 250 may rank candidates in the set based on a muti-factor analysis. For instance, the hiring-recommendation component 250 may rank candidates according to factors that are prioritized. As an illustrative example, predicted tenure may be assigned a first priority, years of experience may be assigned a second priority, and degrees held may be assigned a third priority. In this example, the hiring-recommendation component 250 may begin by ranking the candidates in the set according to their respective predicted tenures. Next, if any two or more candidates in the set have equivalent respective tenures, the hiring-recommendation component 250 may rank those two or more candidates according to their respective years of experience. Next, if any two or more candidates have both equivalent respective tenures and equivalent respective years of experience, the hiring-recommendation component 250 may rank those two or more candidates according to their degrees held. In other examples, more factors, fewer factors, and/or different factors may be used and may be assigned different priorities.

In yet another scenario, the hiring-recommendation component 250 may rank candidates based on a scoring rubric that assigns a respective score to each candidate based on a multi-factor analysis. For instance, in one scenario, the scoring rubric may evaluate the predicted tenure, years of experience, and degrees held for each candidate, and based on that evaluation, the hiring-recommendation component 250 may determine a respective score for each candidate.

The function of generating a hiring recommendation for a given position may also take other forms.

In some implementations, the hiring-recommendation component 250 may initiate a software workflow related to hiring. The functionality that is carried out by the hiring-recommendation component 250 to initiate a software workflow related to hiring may take any of various forms.

As one possibility, the hiring-recommendation component 250 may initiate a software workflow for scheduling an interview with a given candidate based on a hiring recommendation generated for the given candidate. For instance, as one example, the hiring-recommendation component 250 may detect an available block of time on a software-based calendar associated with an employee who has been designated as an interviewer for a position for which the given candidate is under consideration. The hiring-recommendation component 250 may then generate an event (e.g., in the form of a software object) to represent an interview. The event may contain data that (i) specifies that that the event is an interview, (ii) identifies the given candidate as an interviewee, and (iii) specifies the available block of time as the time when the interview is proposed to take place. Optionally, the event may also contain a link to a virtual meeting that may be used to conduct the interview remotely via teleconferencing software. Next, the hiring-recommendation component 250 may send a notification to apprise the interviewer of the event (e.g., in the form of a meeting invite via email, a push notification, and/or an entry on the software-based calendar, among other possibilities).

As another possibility, the hiring-recommendation component 250 may initiate a software workflow for extending a job offer to a given candidate based on a hiring recommendation generated for the given candidate. For instance, as one example, the hiring-recommendation component 250 may begin by loading a digital template for a job offer. To generate a job offer for the given candidate based on the template, the hiring-recommendation component 250 may populate one or more fields in the template with information for the given candidate. Such fields may, for example, include a field for a candidate name, a field for a candidate home address, a field for a candidate phone number, and a field for a position for which the candidate is to be hired, among other possibilities. Next, the hiring-recommendation component 250 may send a notification to an employee who has been designated as a decision-maker for the position. The notification may include a message that (i) indicates the hiring recommendation for the given candidate and (i) includes the generated job offer and/or a link thereto.

The functionality that is carried out by the hiring-recommendation component 250 to initiate a software workflow related to hiring may also take other forms.

As further shown in FIG. 2, the example software-based pipeline 200 may include an output interface 260, which may generally function to cause output data related to tenure predictions output by the candidate-prediction component 230, explanations output by the explainability component 240, and/or hiring recommendations output by the hiring-recommendation component 250 to be presented to a user. The output data that is presented may take any of various forms.

For instance, as one possibility, the output data may comprise a listing of one or more candidates along with a respective tenure prediction for each of the one or more candidates. The listing may, for example, identify the one or more candidates by their respective names. The manner in which the output interface 260 selects the one or more candidates for inclusion in the listing may take any of various forms.

For instance, in one example, the output interface 260 may select the one or more candidates based on respective hiring recommendations for the one or more candidates. In one scenario, the output interface 260 may exclude candidates whose respective hiring recommendations indicate that the hiring-recommendation component 250 does not recommend they be hired. In this example, the result may be that each of the one or more candidates included in the listing is recommended for hire by the hiring-recommendation component 250.

In another example, the output interface 260 may select the one or more candidates based on a particular position for which the one or more candidates are under consideration. In one scenario, the output interface 260 may exclude candidates who are not under consideration for the particular position. In this example, the result may be that each of the one or more candidates included in the listing is under consideration for the particular position.

In yet another example, the output interface 260 may include each candidate who is under consideration for any position with the employer in the one or more candidates included in the listing.

The manner in which the output interface selects the one or more candidates for inclusion in the listing that includes respective tenure predictions may also take other forms.

As another possibility, the output data may comprise a listing of one or more candidates along with a respective hiring recommendation for each of the one or more candidates. The listing may, for example, identify the one or more candidates by their respective names. The manner in which the output interface 260 selects the one or more candidates for inclusion in the listing may take any of various forms.

For instance, in one example, the output interface 260 may select the one or more candidates based on respective tenure predictions for the one or more candidates. In one scenario, the output interface 260 may exclude candidates whose respective predicted tenures are less than a threshold length of time. In this example, the result may be that each of the one or more candidates included in the listing is predicted to stay with the employer for the at least the threshold period of time if hired.

In another example, the output interface 260 may select the one or more candidates based on a particular position for which the one or more candidates are under consideration. In one scenario, the output interface 260 may exclude candidates who are not under consideration for the particular position. In this example, the result may be that each of the one or more candidates included in the listing is under consideration for the particular position.

In another example, the output interface 260 may include each candidate who is under consideration for any position with the employer in the one or more candidates included in the listing.

The manner in which the output interface selects the one or more candidates for inclusion in the listing that includes respective hiring predictions may also take other forms.

As yet another possibility, the output data may comprise a listing of one or more candidates along with a respective tenure prediction and a respective hiring recommendation for each of the one or more candidates. The manner in which the output interface 260 selects the one or more candidates for inclusion in the listing may take any of various forms.

For instance, in one example, the output interface 260 may select the one or more candidates based on respective hiring recommendations for the one or more candidates. In one scenario, the output interface 260 may exclude candidates whose respective hiring recommendations indicate that the hiring-recommendation component 250 does not recommend they be hired. In this example, the result may be that each of the one or more candidates included in the listing is recommended for hire by the hiring-recommendation component 250.

In another example, the output interface 260 may select the one or more candidates based on respective tenure predictions for the one or more candidates. In one scenario, the output interface 260 may exclude candidates whose respective predicted tenures are less than a threshold length of time. In this example, the result may be that each of the one or more candidates included in the listing is predicted to stay with the employer for the at least the threshold period of time if hired.

In yet another example, the output interface 260 may select the one or more candidates based on a particular position for which the one or more candidates are under consideration. In one scenario, the output interface 260 may exclude candidates who are not under consideration for the particular position. In this example, the result may be that each of the one or more candidates included in the listing is under consideration for the particular position.

In yet another example, the output interface 260 may include each candidate who is under consideration for any position with the employer in the one or more candidates included in the listing.

The manner in which the output interface selects the one or more candidates for inclusion in the listing that includes both respective tenure predictions and respective hiring recommendations may also take other forms.

As yet another possibility, in implementations where the output data includes respective tenure predictions for the one or more candidates, the output data may further comprise respective explanations generated by the explainability component 240 for the one or more candidates.

The output data that the output interface 260 causes to be presented may also take other forms.

Further, the manner in which the output interface 260 causes the output data to be presented may take any of various forms. For instance, as one possibility, the output interface 260 may cause a listing of one or more candidates and respective tenure predictions and/or hiring recommendations to be presented in any of various possible views (e.g., a dashboard, a tab, etc.) of a user interface on a client device.

In one example, the listing may be presented in a form that allows a user to filter candidates based on criteria such as the positions for which the candidates are being considered, departments of the positions, job function of the positions, lengths of predicted tenures, and/or hiring predictions, among other possibilities.

In another example, the output interface 260 may cause the client device associated with the user to display a visual indication (e.g., a flag or some other type of visual indication) near the names of top-ranked candidates who are ranked first among the one or more candidates for a position for which the top-ranked candidates are being considered.

In yet another example, the output interface 260 may cause the client device to display the listing may in a form that hides some aspects of the output data by default, but allows the user to view those aspects of the output data in response to user input. For instance, in one scenario, a client device may initially display candidate names and respective predicted tenures, but hide other aspects of the output data. In this scenario, when a user clicks on a candidate's name in the listing, a hiring recommendation for the candidate may be displayed (e.g., in a column of the listing that is unhidden in response to the click, in a message balloon that pops up in response to the click, or in some other element that is displayed in response to the click). In other scenarios, different aspects of the output data may be displayed or hidden by default.

The manner in which the output interface 260 causes the output data to be presented may also take other forms.

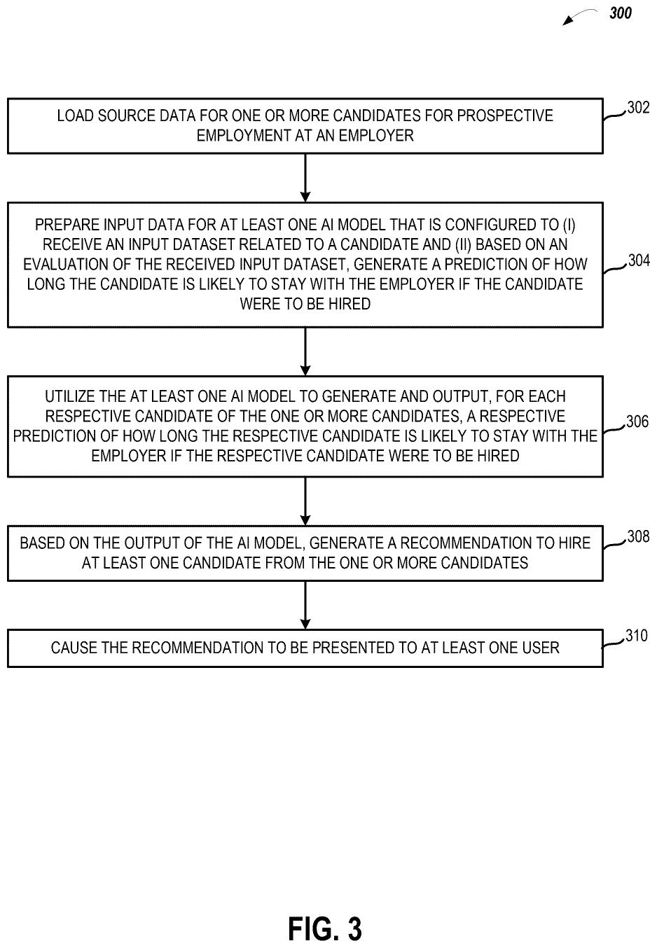

One possible example of functionality 300 that may be carried out in accordance with the disclosed software technology will now be described with reference to the flow chart of FIG. 3. In practice, the functionality 300 of FIG. 3 may be encoded in the form of program instructions that are executable by one or more processors of a computing platform, and for purposes of illustration, the functionality 300 of FIG. 3 is described as being carried out by the back-end computing platform 102 of FIG. 1, but it should be understood that the functionality 300 of FIG. 3 may be carried out by any one or more computing platforms that are capable of being installed with software for performing the functions described below. Further, it should be understood that the functionality 300 of FIG. 3 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

In line with discussion above, the functionality 300 may begin at block 302 with the back-end computing platform 102 loading source data for one or more candidates for prospective employment at an employer. The loaded source data may take any of various forms. For instance, the loaded source data may comprise structured source data and/or unstructured source data, among other possibilities.

At block 304, the back-end computing platform 102 may, based on the loaded source data, prepare input data for at least one AI model that is configured to (i) receive an input dataset related to a candidate and (ii) based on an evaluation of the received input dataset, generate a prediction of how long the candidate is likely to stay with the employer if the candidate were to be hired. The manner in which the back-end computing platform 102 prepares the input data may take any of various forms.

For instance, in some examples, preparing the input data for the at least one AI model may comprise transforming unstructured source data into structured feature data, transforming structured source data into structured feature data, and/or transforming unstructured source data into unstructured feature data. Structured feature data may comprise respective feature values that map to feature variables. The feature variables may be included in a set of feature variables specified by a schema.

The manner in which the back-end computing platform 102 prepares the input data may also take other forms.

In some examples, the back-end computing platform 102 may train the at least one AI model by applying a machine-learning process to training data comprising historical data related to one or both of current employees of the employer or former employees of the employer.

Further, in some examples, the at least one AI model may comprise a first AI model that is configured to receive structured feature data as input and a second AI model that is configured to receive unstructured feature data as input.

At block 306, the back-end computing platform 102 may utilize the at least one AI model to generate and output, for each respective candidate of the one or more candidates, a respective prediction of how long the respective candidate is likely to stay with the employer if the respective candidate were to be hired. The manner in which the back-end computing platform 102 utilizes the at least one AI model to generate and output the respective predictions may take any of various forms.

For instance, in examples where the at least one AI model comprises a first AI model and a second AI model, the back-end computing platform 102 may utilize the first AI model to generate and output, for each respective candidate of the one or more candidates, a respective first intermediate prediction of how long the respective candidate is likely to stay with the employer if the respective candidate were to be hired; utilize the second AI model to generate and output, for each respective candidate of the one or more candidates, a respective second intermediate prediction of how long the respective candidate is likely to stay with the employer if the respective candidate were to be hired; and aggregate the first intermediate prediction and the second intermediate prediction into the respective prediction of how long the respective candidate is likely to stay with the employer if the respective candidate were to be hired.

The manner in which the back-end computing platform 102 utilizes the at least one AI model to generate and output the respective predictions may also take other forms.

In some examples, the back-end computing platform 102 may utilize a model explainability technique to quantify and output, for each respective candidate of the one or more candidates, a respective set of feature contribution values for a set of feature variables (e.g., the feature variables to which feature values in structured feature data map).

The input dataset may comprise feature data. For example, the input dataset may comprise structured feature data and/or unstructured feature data.

At block 308, the back-end computing platform 102 may, based on the output of the AI model, generate a recommendation to hire at least candidate from the one or more candidates.

At block 310, the back-end computing platform 102 may cause the recommendation to be presented to at least one user (e.g., a user of the back-end computing platform 102). The manner in which the back-end computing platform 102 causes the recommendation to be presented may take any of various forms.

For instance, as one possibility, the back-end computing platform 102 may transmit one or more messages that instruct a client device to present the recommendation to the at least one user.

The manner in which the back-end computing platform 102 causes the recommendation to be presented may also take other forms.

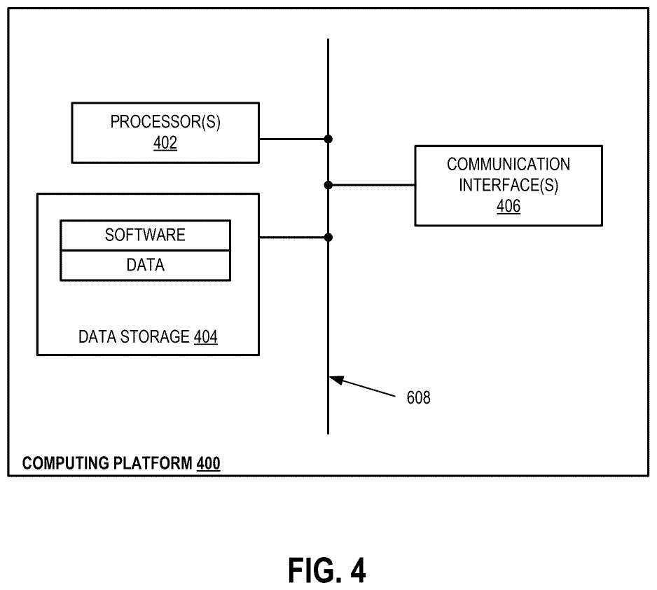

Turning now to FIG. 4, a simplified block diagram is provided to illustrate some structural components that may be included in an example computing platform 400 that may be configured to perform some or all of the platform functions disclosed herein. At a high level, the example computing platform 400 may generally comprise any one or more computer systems (e.g., one or more servers) that collectively include one or more processors 402, data storage 404, and one or more communication interfaces 406, all of which may be communicatively linked by a communication link 408 that may take the form of a system bus, a communication network such as a public, private, or hybrid cloud, or some other connection mechanism. Each of these components may take various forms.

For instance, the one or more processors 402 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 402 could comprise processing components that are distributed across a plurality of physical computing devices connected via a network, such as a computing cluster of a public, private, or hybrid cloud.

In turn, the data storage 404 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 404 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 4, the data storage 404 may be capable of storing both (i) program instructions that are executable by the one or more processors 402 such that the example computing platform 400 is configured to perform any of the various functions disclosed herein (including but not limited to any of the platform functions discussed above), and (ii) data that may be received, derived, or otherwise stored by the example computing platform 400.

The one or more communication interfaces 406 may comprise one or more interfaces that facilitate communication between the example computing platform 400 and other systems or devices, where each such interface may be wired and/or wireless and may communicate according to any of various communication protocols. As examples, the one or more communication interfaces 406 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 400 may additionally have an I/O interface that includes or provides connectivity to I/O components that facilitate user interaction with the example computing platform 400, such as a keyboard, a mouse, a trackpad, a display screen, a touch-sensitive interface, a stylus, a virtual-reality headset, and/or one or more speaker components, among other possibilities.

It should be understood that the example computing platform 400 is one example of a computing platform that may be used with the embodiments described herein. Numerous other arrangements are possible and contemplated herein. For instance, in other embodiments, the example computing platform 400 may include additional components not pictured and/or more or less of the pictured components.

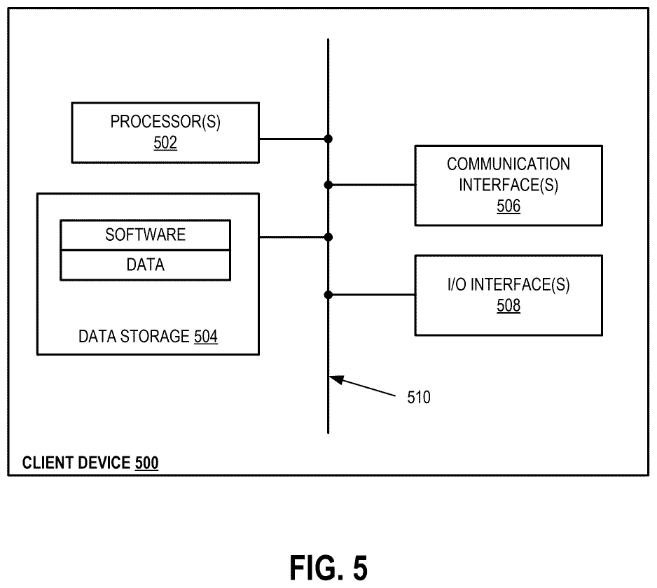

Turning next to FIG. 5, a simplified block diagram is provided to illustrate some structural components that may be included in an example client device 500 that may be configured to perform some or all of the client-device functions disclosed herein. At a high level, the example client device 500 may include one or more processors 502, data storage 504, one or more communication interfaces 506, and an I/O interface 508, all of which may be communicatively linked by a communication link 510 that may take the form a system bus and/or some other connection mechanism. Each of these components may take various forms.

For instance, the one or more processors 502 of the example client device 500 may comprise one or more processor components, such as one or more CPUs, GPUs, ASICs, DSPs, and/or programmable logic devices such as FPGAs, among other possible types of processing components.

In turn, the data storage 504 of the example client device 500 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 5, the data storage 504 may be capable of storing both (i) program instructions that are executable by the one or more processors 502 of the example client device 500 such that the example client device 500 is configured to perform any of the various functions disclosed herein (including but not limited to any of the client-device functions discussed above), and (ii) data that may be received, derived, or otherwise stored by the example client device 500.

The one or more communication interfaces 506 may comprise one or more interfaces that facilitate communication between the example client device 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 508 may generally take the form of (i) one or more input interfaces that are configured to receive and/or capture information at the example client device 500 and (ii) one or more output interfaces that are configured to output information from the example client device 500 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 508 may include or provide connectivity to output components such as a display screen and/or an audio speaker, among other possibilities.

It should be understood that the example client device 500 is one example of a client device that may be used with the example embodiments described herein. Numerous other arrangements are possible and contemplated herein. For instance, in other embodiments, the example client device 500 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one communication interface;
at least one processor;
at least one non-transitory computer-readable medium; and
program instructions stored on the at least one non-transitory computer-readable medium that, when executed by the at least one processor, cause the computing platform to:
load source data for a plurality of candidates for prospective employment at an employer, wherein the source data comprises a combination of (i) structured source data and (ii) unstructured source data;
pre-process the loaded source data by applying (i) a first set of one or more pre-processing operations to the structured source data and (ii) a second set of one or more pre-processing operations to the unstructured source data, wherein the first set of one or more pre-processing operations differs from the second set of one or more pre-processing operations;
based on pre-processing the loaded source data, prepare input data for at least one artificial intelligence (AI) model that is configured to (i) receive an input dataset related to a candidate and (ii) based on an evaluation of the received input dataset, generate a prediction of how long the candidate is likely to stay with the employer if the candidate were to be hired;
apply the at least one AI model to the input data and thereby generate and output, for each respective candidate of the plurality of candidates, a respective prediction of how long the respective candidate is likely to stay with the employer if the respective candidate were to be hired;
based on the respective predictions that are generated and output by the at least one AI model for the plurality of candidates, generate a recommendation to hire at least one candidate from the plurality of candidates; and
based on the recommendation to hire the at least one candidate, automatically initiate a software workflow related to hiring the at least one candidate.

2. (canceled)

3. The computing platform of claim 1, wherein the input dataset related to the candidate comprises structured input data.

4. The computing platform of claim 3, further comprising program instructions that, when executed by the at least one processor, cause the computing platform to:
utilize a model explainability technique to quantify and output, for each respective candidate of the plurality of candidates, a respective set of feature contribution values for a set of feature variables, wherein the structured input data comprises respective feature values that map to the feature variables.

5. The computing platform of claim 3, wherein:
the second set of one or more pre-processing operations function to transform the unstructured source data into the structured input data.

6. The computing platform of claim 1, wherein the input dataset related to the candidate comprises unstructured input data.

7. The computing platform of claim 1, further comprising program instructions that, when executed by the at least one processor, cause the computing platform to:
train the at least one AI model by applying a machine-learning process to training data comprising historical data related to one or both of current employees of the employer or former employees of the employer.

8. (canceled)

9. The computing platform of claim 1, wherein the at least one AI model comprises a first AI model that is configured to receive a structured input dataset as input and a second AI model that is configured to receive an unstructured input dataset as input, and wherein the program instructions that, when executed by the at least one processor, cause the computing platform to apply the at least one AI model to the input data and thereby generate and output, for each respective candidate of the plurality of candidates, the respective prediction comprise program instructions that, when executed by the at least one processor, cause the computing platform to:
apply the first AI model to a first portion of the input data and thereby generate and output, for each respective candidate of the plurality of candidates, a respective first intermediate prediction of how long the respective candidate is likely to stay with the employer if the respective candidate were to be hired;
apply the second AI model to a second portion of the input data and thereby generate and output, for each respective candidate of the plurality of candidates, a respective second intermediate prediction of how long the respective candidate is likely to stay with the employer if the respective candidate were to be hired; and
aggregate the first intermediate prediction and the second intermediate prediction for each respective candidate of the plurality of candidates into the respective prediction of how long the respective candidate is likely to stay with the employer if the respective candidate were to be hired.

10. A non-transitory computer-readable medium, wherein the non-transitory computer-readable medium is provisioned with program instructions that, when executed by at least one processor, cause a computing platform to:
load source data for a plurality of candidates for prospective employment at an employer, wherein the source data comprises a combination of (i) structured source data and (ii) unstructured source data;
pre-processing the loaded source data by applying (i) a first set of one or more pre-processing operations to the structured source data and (ii) a second set of one or more pre-processing operations to the unstructured source data, wherein the first set of one or more pre-processing operations differs from the second set of one or more pre-processing operations;
based on pre-processing the loaded source data, prepare input data for at least one artificial intelligence (AI) model that is configured to (i) receive an input dataset related to a candidate and (ii) based on an evaluation of the received input dataset, generate a prediction of how long the candidate is likely to stay with the employer if the candidate were to be hired;
apply the at least one AI model to the input data and thereby generate and output, for each respective candidate of the plurality of candidates, a respective prediction of how long the respective candidate is likely to stay with the employer if the respective candidate were to be hired;
based on the respective predictions that are generated and output by the at least one AI model for the plurality of candidates, generate a recommendation to hire at least one candidate from the plurality of candidates; and
based on the recommendation to hire the at least one candidate, automatically initiate a software workflow related to hiring the at least one candidate.

11. The non-transitory computer-readable medium of claim 10, wherein the input dataset related to the candidate comprises structured input data.

12. The non-transitory computer-readable medium of claim 11, wherein the non-transitory computer-readable medium is further provisioned with program instructions that, when executed by at least one processor, cause a computing platform to:
utilize a model explainability technique to quantify and output, for each respective candidate of the plurality of candidates, a respective set of feature contribution values for a set of feature variables, wherein the structured input data comprises respective feature values that map to the feature variables.

13. The non-transitory computer-readable medium of claim 11, wherein:
the second set of one or more pre-processing operations function to transform the unstructured source data into the structured input data.

14. The non-transitory computer-readable medium of claim 10, wherein the input dataset related to the candidate comprises unstructured input data.

15. The non-transitory computer-readable medium of claim 10, wherein the non-transitory computer-readable medium is provisioned with program instructions that, when executed by at least one processor, cause the computing platform to:
train the at least one AI model by applying a machine-learning process to training data comprising historical data related to one or both of current employees of the employer or former employees of the employer.

16. The non-transitory computer-readable medium of claim 10, wherein the at least one AI model comprises a first AI model that is configured to receive a structured input dataset as input and a second AI model that is configured to receive an unstructured input dataset as input, and wherein the program instructions that, when executed by the at least one processor, cause the computing platform to apply the at least one AI model to the input data and thereby generate and output, for each respective candidate of the plurality of candidates, the respective prediction comprise program instructions that, when executed by the at least one processor, cause the computing platform to:
apply the first AI model to a first portion of the input data and thereby generate and output, for each respective candidate of the plurality of candidates, a respective first intermediate prediction of how long the respective candidate is likely to stay with the employer if the respective candidate were to be hired;
apply the second AI model to a second portion of the input data and thereby generate and output, for each respective candidate of the plurality of candidates, a respective second intermediate prediction of how long the respective candidate is likely to stay with the employer if the respective candidate were to be hired; and
aggregate the first intermediate prediction and the second intermediate prediction for each respective candidate of the plurality of candidates into the respective prediction of how long the respective candidate is likely to stay with the employer if the respective candidate were to be hired.

17. A method carried out by a computing platform, the method comprising:
loading source data for a plurality of candidates for prospective employment at an employer, wherein the source data comprises a combination of (i) structured source data and (ii) unstructured source data;
pre-processing the loaded source data by applying (i) a first set of one or more pre-processing operations to the structured source data and (ii) a second set of one or more pre-processing operations to the unstructured source data, wherein the first set of one or more pre-processing operations differs from the second set of one or more pre-processing operations;
based on pre-processing the loaded source data, preparing input data for at least one artificial intelligence (AI) model that is configured to (i) receive an input dataset related to a candidate and (ii) based on an evaluation of the received input dataset, generate a prediction of how long the candidate is likely to stay with the employer if the candidate were to be hired;
applying the at least one AI model to the input data and thereby generating and outputting, for each respective candidate of the plurality of candidates, a respective prediction of how long the respective candidate is likely to stay with the employer if the respective candidate were to be hired;
based on the respective predictions that are generated and output by the at least one AI model for the plurality of candidates, generating a recommendation to hire at least one candidate from the plurality of candidates; and
based on the recommendation to hire the at least one candidate, automatically initiating a software workflow related to hiring the at least one candidate.

18. The method of claim 17, wherein the input dataset related to the candidate comprises structured input data.

19. The method of claim 18, further comprising:
utilizing a model explainability technique to quantify and output, for each respective candidate of the plurality of candidates, a respective set of feature contribution values for a set of feature variables, wherein the structured input data comprises respective feature values that map to the feature variables.

20. The method of claim 17, wherein the at least one AI model comprises a first AI model that is configured to receive a structured input dataset as input and a second AI model that is configured to receive an unstructured input dataset as input, and wherein applying the at least one AI model to the input data and thereby generating and outputting, for each respective candidate of the plurality of candidates, the respective prediction comprises:
applying the first AI model to a first portion of the input data and thereby generating and outputting, for each respective candidate of the plurality of candidates, a respective first intermediate prediction of how long the respective candidate is likely to stay with the employer if the respective candidate were to be hired;
applying the second AI model to a second portion of the input data and thereby generating and outputting, for each respective candidate of the plurality of candidates, a respective second intermediate prediction of how long the respective candidate is likely to stay with the employer if the respective candidate were to be hired; and
aggregating the first intermediate prediction and the second intermediate prediction for each respective candidate of the plurality of candidates into the respective prediction of how long the respective candidate is likely to stay with the employer if the respective candidate were to be hired.

21. The computing platform of claim 1, wherein the unstructured source data comprises one or more of textual data, audio data, or image data related to the plurality of candidates.

22. The computing platform of claim 1, wherein the software workflow related to hiring the at least one candidate comprises at least one of (i) a software workflow for scheduling an interview with the at least one candidate or (ii) a software workflow for extending a job offer to the at least one candidate.
